(19) United States
(12) Patent Application Publication
(10) Pub. No.: US 2009/0179040 A1
(43) Pub. Date: Jul. 16, 2009

(54) Method and apparatus for an ice level determiner

(75) Inventor: John T. Hawkins, Adkins, TX (US)

Correspondence Address: LAW OFFICES OF CHRISTOPHER L. MAKAY, 1634 Milam Building, 115 East Travis Street, San Antonio, TX, 78205, US

(73) Assignee: Lancer Partnership, Ltd.

(21) Appl. No.: 12/009,067

(22) Filed: Jan. 16, 2008

(51) Int. Cl. G07F 11/00; B65H 3/60

(52) U.S. Cl. 221/1; 221/10; 221/2; 221/200

(57) ABSTRACT

A product supply management system provides the capability to regulate the delivery of a product into a containment device. The containment device may be part of a product dispenser, such that the product dispenser regulates the delivery of product from a product generator. In a first embodiment, the product level determiners are disposed at varying levels of the containment device, and are in electrical communication with a controller, such that the product level determiners provide information to the controller. This invention further includes a product height profile having multiple time intervals, and a required product level for each time interval. Accordingly, the product supply management system may compare product levels to the product height profile, and determine whether additional product is required. The product height profile may include relative timing device, data set or real-time timing device to control the timing portion of the invention. Alternative embodiments are further provided.

### BACKGROUND OF THE INVENTION

1. Field of the Invention

The present invention relates to product dispensing equipment and, more particularly, but not by way of limitation, to methods and an apparatus for optimizing a maximum ice height in a product dispenser.

2. Description of the Related Art

In the product dispensing industry, retail accounts are typically sized to accommodate peak demand requirements. While this process ensures that substantially all customers are able to draw a drink with ice if so desired, it also forces the establishment to maintain peak load amounts of refreshment components during non-peak load periods. As such, most account locations have larger capacity ice bins that are depleted during a peak period, and refilled after the peak period. Accordingly, ice may remain in the ice bin for extended periods.

Problems arise when ice sits for extended periods, as the ice cubes tend to melt and bridge together. Ice management problems are amplified in the larger capacity ice dispensing units, as the ice column is taller and increased loading is experienced at a lower end of the ice column. The increased loads are then translated to an agitation device as it moves through the ice column, thereby placing more stress on agitator components. Increased stress on the agitator components leads to increased wear and an increased failure rate of the agitator motor and the agitation related components.

Consequently, agitator motor related problems are the service call category with the highest number of occurrences. After a failure in the agitator motor area occurs, the ice begins to bridge together, and ice dispensing operations may be limited. The situation is further complicated because an icemaker is typically located above the ice bin, thereby requiring the ice maker to be moved to gain access to the agitation devices or related components. Still further, the ice disposed in the ice bin must be melted to gain access to the agitation devices, thereby extending a down time due to the agitation device failure.

Accordingly, a product level management system for a product dispenser that would adjust a maximum height of an ice column in a product dispenser to a level dependent upon a known loading schedule would be beneficial to beverage dispenser manufacturers, as well as establishments that dispense beverages from beverage dispensing equipment.

### SUMMARY OF THE INVENTION

In accordance with the present invention, a product supply management system provides the capability to regulate the delivery of a product into a containment device. The containment device may be part of a product dispenser, such that the product dispenser regulates the delivery of product from a product generator. In a first embodiment, the product level determiners are disposed at varying levels of the containment device, and are in electrical communication with a controller, such that the product level determiners provide information to the controller. This invention further includes a product height profile having multiple time intervals, and a required product level for each time interval. Accordingly, the product supply management system may compare product levels to the product height profile, and determine whether more product is required. The product height profile may include a relative timing device, or a data set.

In a second embodiment, the product supply management system includes a real-time clocking device that provides the ability to schedule the intervals of the product height profile on the real-time clock. In an extension of the second embodiment, the system includes a self-monitoring function that allows the controller to override the predetermined product height profile programming when an observed usage during the current product height profile interval projected over the remainder of the interval is greater than the actual level of product in the containment device. In a further extension, the controller may create product height profiles based on usage patterns.

In a third embodiment, the product generator includes the controller that regulates the supply of product to the containment device.

In a fourth embodiment, the product generator includes a real-time clocking device such as that disclosed in the second embodiment.

In an alternative embodiment, the determination of the product level in the containment device is accomplished by monitoring a voltage on a driver of the agitation means.

It is therefore an object of the present invention to provide a product supply management system that regulates the delivery of a product to a containment device.

It is a further object of the present invention to provide a product generator that regulates the delivery of product to a containment device of a separate product dispenser.

It is still further an object of the present invention to provide a product supply management system that measures the electric load on a motor of an agitation device to discern product levels.

Still other objects, features, and advantages of the present invention will become evident to those of ordinary skill in the art in light of the following. Also, it should be understood that the scope of this invention is intended to be broad, and any combination of any subset of the features, elements, or steps described herein is part of the intended scope of the invention.

### BRIEF DESCRIPTION OF THE DRAWINGS

FIG. 1a provides a perspective view of a product supply management system according to a first embodiment.

FIG. 1b provides an example of a product height profile program according to the first embodiment.

FIG. 1c provides a method flowchart illustrating the method steps for utilizing the product supply management system according to the first embodiment.

FIG. 2a provides a product dispensing system according to the first embodiment.

FIG. 2b provides a cross section view of the product dispensing system according to the first embodiment.

FIG. 3 provides a detail view of the product dispensing system according to the first embodiment.

FIG. 4 provides a flowchart illustrating the method steps for determining a product height in a storage bin according to the first embodiment.

FIG. 5 provides a perspective view of a product dispenser according to a second embodiment.

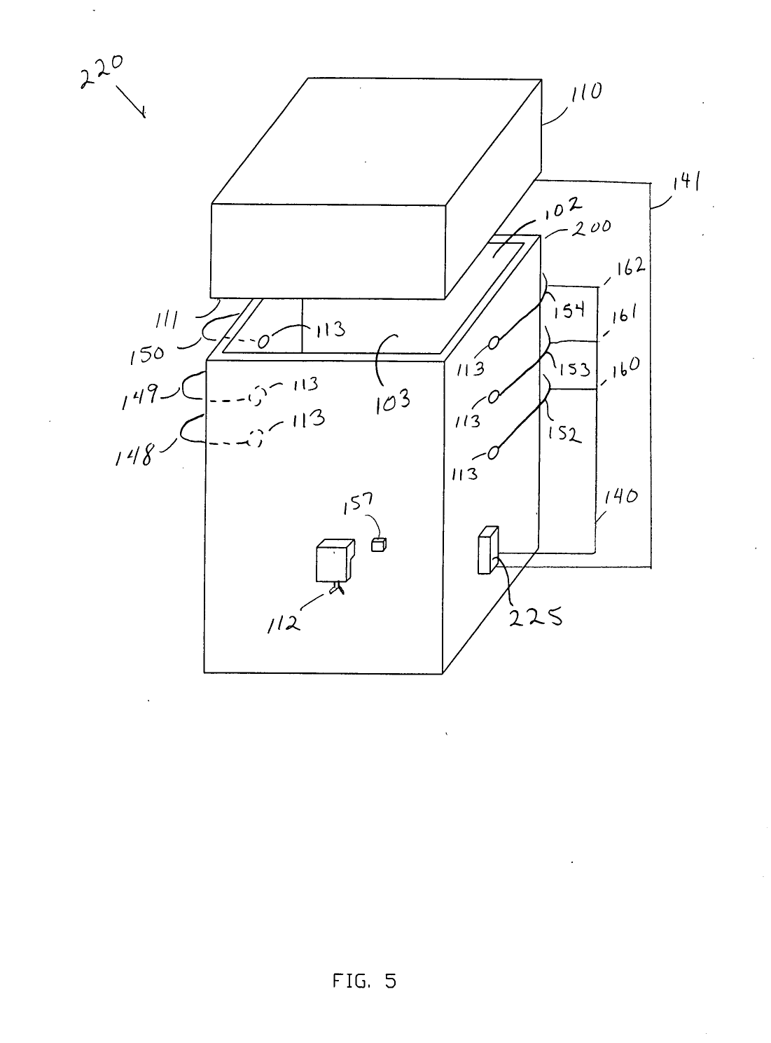

FIG. 6 provides a flowchart illustrating the method steps for a controller conducting all of the timing operations.

FIG. 7 provides a flowchart illustrating the method steps for projecting a required quantity of product for an interval according to the second embodiment.

FIG. 8a provides a flowchart illustrating the method steps for conducting a teach and learn feature of the second embodiment.

FIG. 8b provides a flowchart illustrating the method steps for a product level hold routine according to the second embodiment.

FIG. 9a provides a product dispensing system wherein a product generator determines a height of a product in the product dispenser according to a third embodiment.

FIG. 9b provides a product dispensing system wherein a product generator includes a real-time clocking mechanism according to a fourth embodiment.

FIG. 10a provides a cross section of a product dispenser wherein a product height is determined by monitoring a voltage applied to a driver according to a fifth embodiment.

FIG. 10b provides an electrical schematic for a driver in the fifth embodiment.

FIG. 10c provides a flowchart illustrating the method steps for a product level sensing system according to the fifth embodiment.

FIG. 11a provides a schematic illustrating the process of determining an adjusted ice remaining quantity according to a sixth embodiment.

FIG. 11b provides a lookup table for environmental efficiency factors utilized determining an adjusted ice remaining quantity according to the sixth embodiment.

FIG. 11c provides a flowchart illustrating the method steps for determining the remaining ice level utilizing system parameters according to the sixth embodiment.

### DETAILED DESCRIPTION OF THE PREFERRED EMBODIMENT

As required, detailed embodiments of the present invention are disclosed herein; however, it is to be understood that the disclosed embodiments are merely exemplary of the invention, which may be embodied in various forms. It is further to be understood that the figures are not necessarily to scale, and some features may be exaggerated to show details of particular components or steps.

In this invention, a product supply management system provides the ability to determine a height of a product disposed within a storage chamber, compare the product height to a product height profile, and conduct appropriate operations in response to the comparison between the existing height measurement and the product height profile. The determination of the product height is accomplished through direct measurement or indirectly through system parameters.

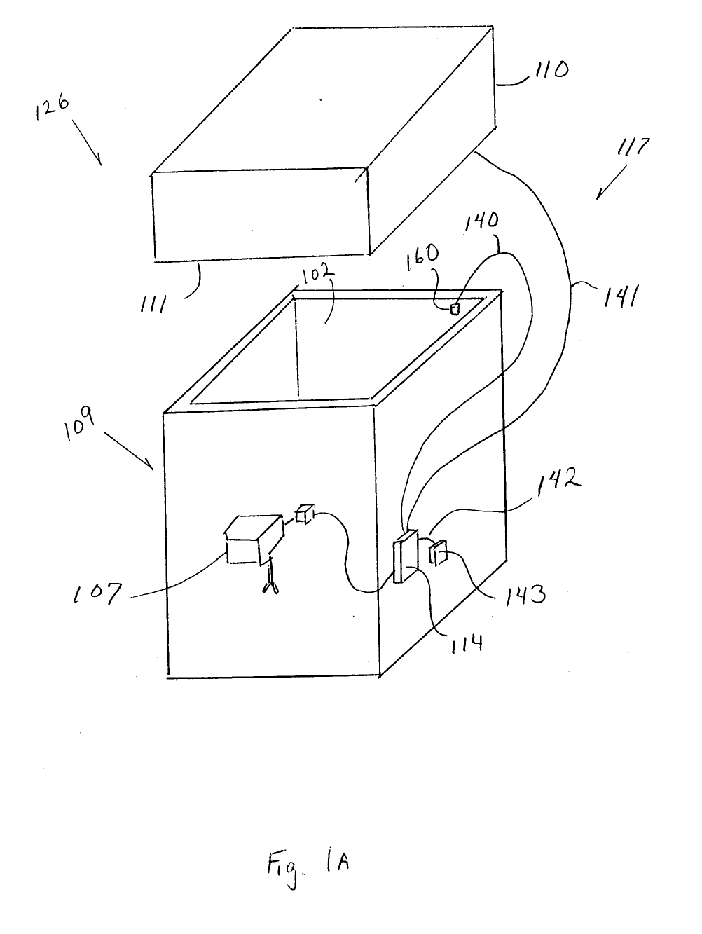

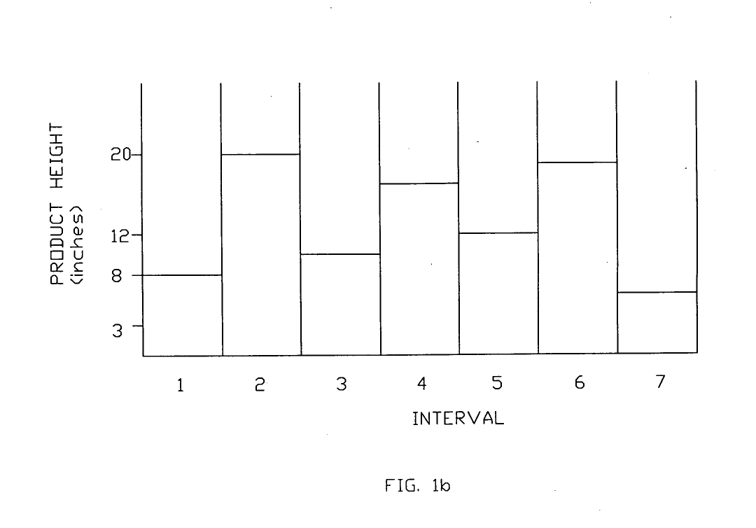

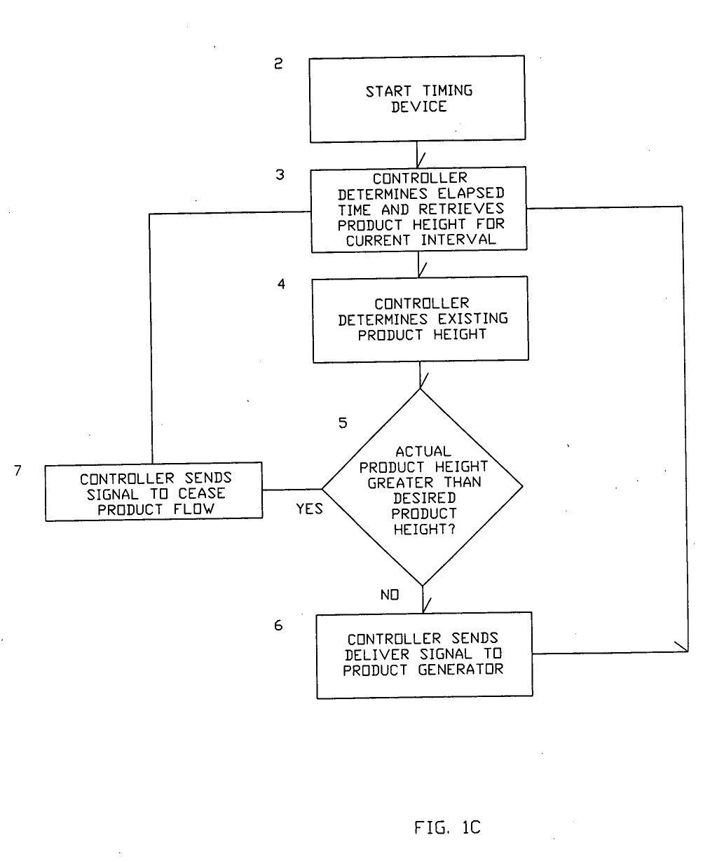

In a simplest form, a product supply management system 126 includes a product generator 110, a containment device 109, a timing device 143, a product level determiner 160, and a control system 117 for regulating the production of a product from the product generator 110 and the delivery of the product to a storage chamber 102 in the containment device 109. As shown in FIG. 1A, the control system 117 includes a controller 114, an input harness 140, an output lead 141, and timing lead 142. The input harness 140 is in electrical communication with product level determiner 160 and the controller 114, such that the product level determiner 160 may transmit signals to the controller 114. The output lead 141 is in electrical communication with the product generator 110, such that the controller 114 may deliver electrical signals to the product generator 110. The timing lead 142 is in electrical communication with the timing device 143 and the controller 114, such that the timing device 143 conveys an elapsed time to the controller 114.

The controller 114 regulates and conducts dispensing and related operations. In this first embodiment, the controller 114 is a processing device that does not include a real-time clock. The controller 114 is disposed in the housing of the containment device 109, and may be accessible by an operator during setup and configuration routines. The controller 114 may be any form of controlling device, including microprocessors, microcontrollers, microprocessors, and the like.

The timing device 143 may be any type of relative timing device, including mechanical timers and mechanical switches. In this first embodiment, the timing device 143 is a mechanical timer that includes the ability to deliver product requirement information. Illustratively, the timing device 143 includes a rotating circular plate including plate segments of varying radii, wherein the different radius measurements are translated to product requirement information by the controller 114.

The product supply management system 126 further includes a product profile, which is a data set representing desired product amounts over successive predetermined periods. In this embodiment, the product profile is based on a height of a product disposed within the storage chamber 102. Accordingly, a product height profile represents a data set of desired product heights in the storage chamber 102 over successive predetermined periods.

As shown in FIG. 1B, the product height profile includes product height requirement information for product height profile intervals 1-7. Illustratively, the product height profile interval one requires a product height of eight inches, and extends for six hours from the commencement point. The product height profile interval two requires a product height profile of twenty inches, and extends for two hours to cover nominal morning usage. In similar fashion, the third through seventh product height profile intervals follow with specific product height requirements. The product height profile further provides a product height requirement to the controller 114 based on a timing sequence. In this first embodiment, the timing sequence is regulated by the timing device 143. The product height profile includes varying requirements for predetermined successive product height profile intervals, thereby creating a schedule of predetermined product height requirements. One of ordinary skill in the art will recognize that the duration and quantity of the intervals may be adjusted to coincide with high demand periods, as well as low demand periods.

A commencement point and an ending point of the product height profile may be tied together to create a circular loop, thereby creating a continuous product height profile program. Illustratively, the end of product height profile interval seven may be tied to the commencement point of product height profile interval one, thereby creating the circular loop. The product height profile may be configurable to provide flexibility and be adaptable to specific dispensing location requirements. The product supply management system 126 may further include a second product height profile to provide an alternate scheduling regime. Illustratively, the product supply management system 126 may comprise a weekday schedule and a weekend schedule to accommodate varying peak loading situations.

The containment device 109 may be any form of product containment device that holds or contains a product. Illustratively, the containment device 109 may be part of another dispensing or delivery system, such as a shroud for beverage dispenser, or a bowl of fluid. In this embodiment, the containment device 109 includes a storage chamber 102 for storing a product. The storage chamber 102 disposed within the containment device 109 may be suitable for housing virtually any type of fluid or particulate for use or consumption, and may include a dispensing port 107 for the removal of product. In this embodiment, a top portion of the containment device 109 is open to accept the product.

The product generator 110 may be any type of product generation device, including icemakers, grinders, food product processors, and the like. In this embodiment, the product generator 110 dispenses the product from an outlet 111, such that dispensed product drops into the storage chamber 102 of the containment device 109. One of ordinary skill in the art will recognize that product generators may be designed to continuously produce ice, or may be designed to operate on-demand, such that a signal is required to deliver product. This invention is suitable for addressing both types of operating systems. Illustratively, in an “always on” mode, the controller 114 must send a disarm signal when product is not required, and in an “on-demand” mode, the controller 114 would send a demand signal when additional product is required. Accordingly, both types of control schemes are considered part of this invention.

While this invention has been shown with a product profile based on a product height, one of ordinary skill in the art will recognize that the product profile is really based on an amount of product disposed within the storage bin 102. One of ordinary skill in the art will further recognize that alternative methods for quantifying the amount of product disposed in the storage chamber may be utilized, including weighing the product disposed within the storage chamber, breaking the storage bin into zones and determining the zones that are occupied through the use of optics, and the like. One of ordinary skill in the art will still further recognize that the use of product heights for the regulation of a product is acceptable if the capacity of the storage chamber 102 at the various levels is known or can be derived. In this invention all levels of product may be converted to an amount of product disposed within the storage chamber 102.

The product level determiner 160 may be any form of product level detection device known in the product dispensing industry, including temperature probes at varying heights, ultrasonic methods, visual methods, and the like. In this embodiment, the product level determiner 160 is an ultrasonic transceiver that emits and receives acoustic signals, and generates a signal in proportion to distances of objects located in front of the ultrasonic transceiver. Accordingly, the controller 114 receives signals from the transceiver, and converts the signals to a product height that can be converted to a product quantity. In this embodiment, the ultrasonic transceiver is disposed at a highest point of the storage chamber 102, such that the product level determiner 160 resides above the any product disposed within the storage chamber 102. While this embodiment has been shown with an ultrasonic transceiver for a product level determiner 160, one of ordinary skill in the art will recognize that any form of product level determiner may be employed to ascertain a product height or the amount of product disposed within the storage chamber 102.

On assembly, the controller 114 and the timing device 143 are secured to the containment device 109, and then are connected together through the timing lead 142. Next, the product level determiner 160 is inserted into the storage chamber 102, and then the input harness 140 is connected to the product level determiner 160 and the controller 114, such that the product level determiner 160 is in electrical communication with the controller 114. The product generator 110 may then be placed onto the containment device 109, such that the outlet 111 is disposed above the storage chamber 102. The output lead 141 is then coupled to the controller 114 and the product generator 110, such that the controller 114 is in electrical communication with the product generator 110.

In use, the controller 114 conducts the generation and delivery of product from the product generator 110. As shown in FIG. 1C, the process for utilizing the product supply management system 126 commences with step 2, wherein an operator starts a timing sequence to be executed by the timing device 143. Once the timing sequence has been started, the controller 114 may retrieve an elapsed time of the timing sequence from the timing device, and retrieves the desired product height for the current product height profile interval from a look up table. Alternatively, the controller 114 may retrieve the timing information and product requirement information from a relative measurement such as those conveyed through the use of disc including arc segments of varying radii. In this instance, the product requirement information is a desired product height in the storage chamber for the current product height profile interval, step 3. The controller 114 then determines the height of the product disposed within the storage chamber 102 through the use of the product level determiner 160, step 4.

Once the current product height is determined, the controller 114 moves to step 5, wherein it must determine if the actual product height is greater than the desired product height for the current product height profile interval. If the actual product height in step 5 is greater than the desired product height for the current product height profile interval, the controller 114 moves to step 7, wherein it sends a signal to cease the flow of product to the storage chamber 102. Upon the completion of the cease product signal, the controller 114 returns to step 3 to determine the new time and desired product height. If the controller 114 determines in step 5 that the actual product height is not greater than the desired product height for the current product height profile interval, the controller 114 moves to step 6, wherein the controller 114 sends a delivery request signal to the product generator 110. After the transmission of the delivery request signal to the product generator 110, the controller 114 returns to step 5 for a new comparison of the actual product height and the desired product height. Accordingly, the process continues to send product requirement signals until the actual product height is achieved or a new product height profile interval height is received by the controller 114.

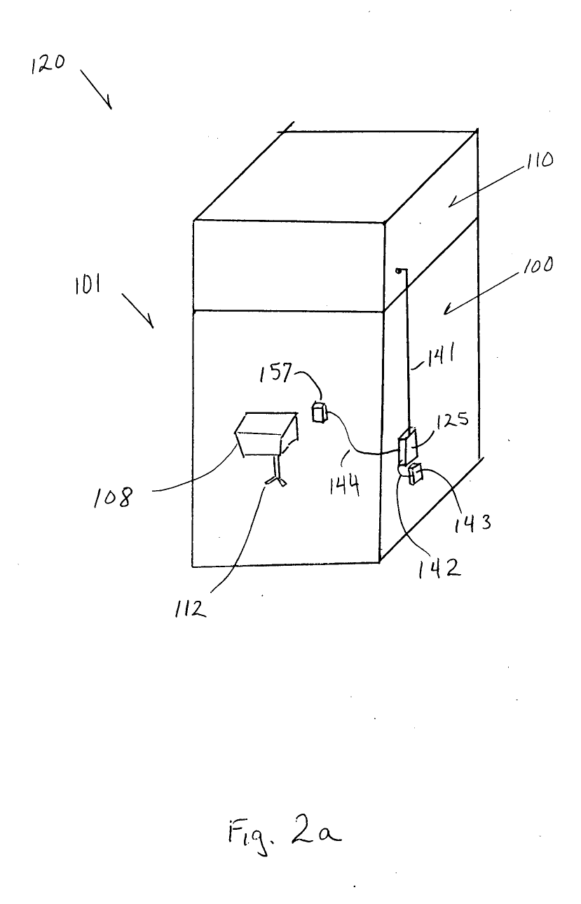

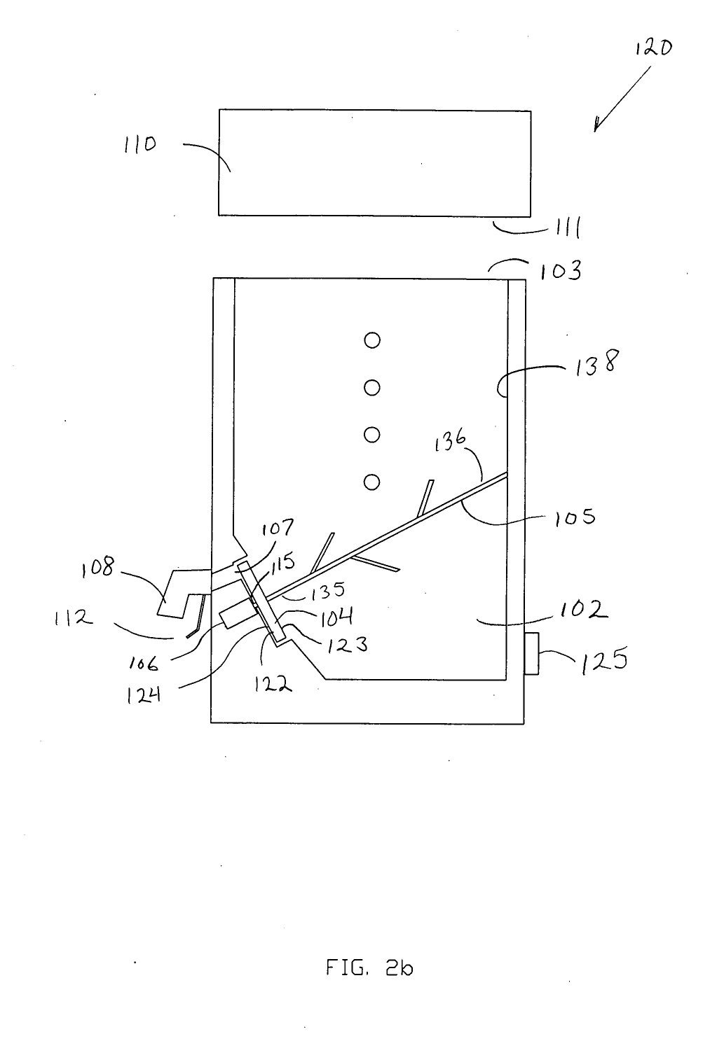

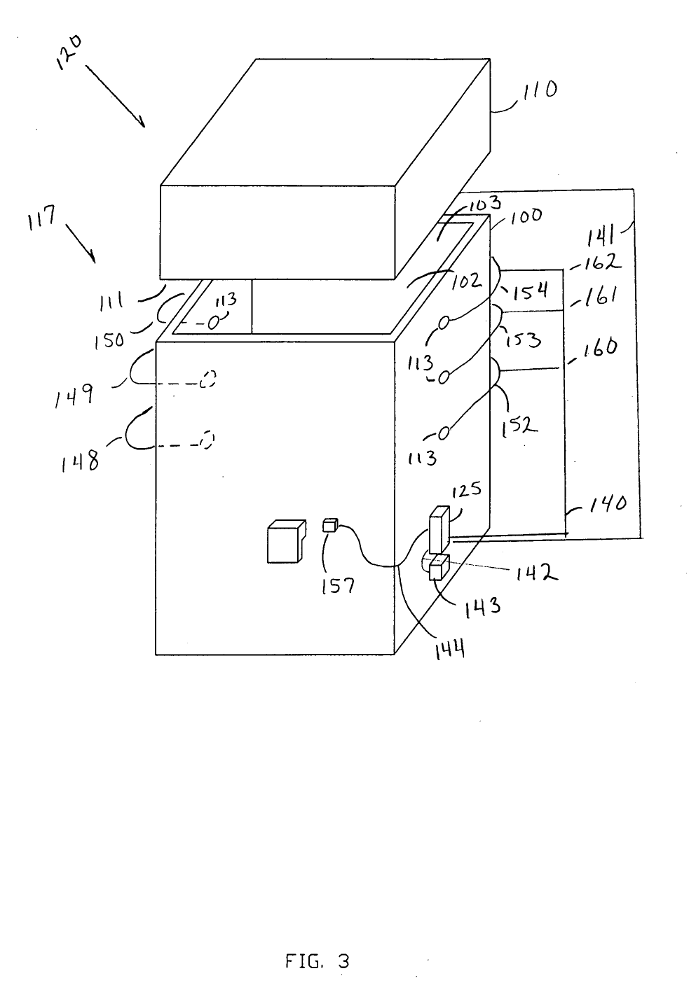

In an extension of the first embodiment, as shown in FIGS. 2a-3, the product supply management system 126 is utilized in a product dispensing system 120 having a product dispenser 100 and a product generator 110. The product dispensing system 120 includes the control system 117 of the product supply management system 126, wherein a controller 125 is in electrical communication with a timing device 143 through a timing lead 142, the product generator 110 through an output lead 141, and product level determiners 160 through an input lead 140.

The product dispenser 100 is suitable for the dispensing of various products, including grains, dry products, ice, and the like. The product dispenser 100 may include a housing 101 having a storage chamber 102. The storage chamber 102 may further include a port 103 on a top of the product dispenser 100, such that a product may be supplied through the port 103 for storage and dispensing operations. In this extension of the first embodiment, the product generator 110 is disposed atop the product dispenser 100, such that an outlet 111 of the product generator 110 is disposed above the port 103 leading to the storage chamber 102.

The storage chamber 102 of the product dispenser 100 may further include a driver port 115 in a lower portion of a front of the product dispenser 100, such that a driver 106 mounts to the front of the housing 101 and an output shaft of the driver 106 protrudes through the driver port 115 to gain access to the storage chamber 102. The product dispenser 100 may further include a paddlewheel 104 disposed within the storage chamber 102. The paddlewheel 104 may include a body, tangs disposed about the body, and a central aperture extending from a first face 122 to a second face 123. The paddlewheel 104 is disposed within the storage chamber 102 such that the first face 122 of the paddlewheel 104 is located at a predetermined distance from a front face 124 of storage chamber 102, and the central aperture is disposed onto the output shaft of the driver 106. The paddlewheel 104 may be secured to the output shaft using any suitable means, including pins, screws, couplers, and the like. One of ordinary skill in the art will recognize that this connection may be removable for cleansing, maintenance, or replacement of components.

The product dispenser 100 may further include an agitation device. In this example, the agitation device is an agitator 105 disposed within the storage chamber 102. The agitator 105 may include an agitator bar, and a first arm. A second arm may provide additional coverage of product disposed within the storage chamber 102. The agitator 105 may be constructed from any material suitable for use in a food contact environment. Illustratively, the agitator 105 may be constructed from stainless steel for strength and food contact criteria. A first end 135 of the agitator 105 may suitable for connection to the output shaft of the driver 106, or the central aperture of the paddlewheel 104. A second end 136 of the agitator bar 132 may be connectable to a support point 139 on a rear wall 138 of the storage chamber 102. Once the first end 135 of the agitator 105 is connected to the output shaft or the central aperture of the paddlewheel 104, the agitator 105 will rotate with the driver 106 and the paddlewheel 104.

The product dispenser 100 may further include a dispensing port 107 on a front of the product dispenser 100 to deliver product portions therethrough. A dispensing chute 108 may surround the dispensing port 107 to direct the flow of dispensed product downward. The product dispenser 100 may further include an actuator 112 and an activation switch 157. The activation switch 157 may be any form of activation means, including a contact switch, a pushbutton, an electronic signal receptor module, or the like. The activation switch 157 may be in communication with the controller 125 through an input lead 144, such that the controller 125 conducts a dispense routine when the activation switch 157 is depressed.

The controller 125 regulates and conducts dispensing and related operations. As in the first embodiment, the controller 125 is a processing device that does not include a real-time clock. The controller 125 is disposed in the housing of the product dispenser 100, and may be accessible by an operator during setup and configuration routines. The controller 125 may be any form of controlling device, including microprocessors, microcontrollers, and the like.

In this extension of the first embodiment, the timing device 143 is identical in form and function to that described in the product supply management system 126, and regulates the required timing sequence.

In this extension of the first embodiment, the product dispenser 100 includes at least one product level determiner 160 disposed about or within the storage chamber 102, and the input harness 140 in electrical communication with the at least one product level determiner 160 and the controller 125. The product level determiner 160 may be any form of product level detection scheme commonly utilized in the industry to ascertain a product height level, including ultrasonic methods, optical emission and detection schemes, temperature sensors, and the like. Regardless of the type of level detection scheme, the product level determiner 160 may include features or hardware to accurately break the full level of the storage chamber 102 into at least two zones that may be deciphered or monitored independently. Illustratively, multiple light emitting and light detection pairs may be placed at varying heights in the storage chamber 102 to independently report to a controller.

In a second example, the product dispenser 100 may include multiple temperature sensors at varying height levels to create at least two independent zones between the temperature sensors. While one of ordinary skill in the art will recognize that a product level determiner 160 may be operated by manual controls and operations, it should be readily apparent that product level determiners 160 are conducive to being controlled by the controller 125, such that the controller 125 may receive input from a product level determiner 160, and may output signals responsive thereto. In this extension of the first embodiment, the product dispenser 100 may further include a first zone harness 152 in communication with the product level determiner 160, a second zone harness 153 in communication with a second zone product level determiner 161, and a third zone harness 154 in communication with a third zone product level determiner 162 that allow communication between the emitter and detector pairs and the input lead 140 of the controller 125.

In this extension of the first embodiment, the controller 125 is in communication with the product level determiners 160 to 162 to discern the existing level of the product disposed within the storage chamber 102. The input lead 140 may include multiple communication points to transmit independent information from all product level zones of the storage chamber 102 to the controller 125. The input lead 140 may also be constructed from any communication means suitable for the delivery of an electronic signal from the product level determiners 160 through 162 to the controller 125. The output lead 141 is in communication with the product generator 110, and may be any form of communication connection means that may be utilized to deliver signals from the controller 125 to the product generator 110. Illustratively, the output lead 141 may be a wire, bus, or other electronic data transfer medium, including wireless communications.

The product dispenser 100 further includes a product height profile as described in the first embodiment that provides a data set of desired product heights in the storage chamber 102 over successive predetermined intervals to the controller 125. The product height profile provides product height requirement information to the controller 125 based on a timing sequence regulated by the timing device 143. The product height profile includes varying requirements for predetermined successive intervals, thereby creating a schedule of predetermined product height requirements. One of ordinary skill in the art will recognize that the duration and quantity of the intervals may be adjusted to coincide with high demand periods, as well as low demand periods.

A commencement point and an ending point of the product height profile may further be tied together to create a circular loop, thereby creating a continuous product height profile program. The product height profile may be configurable to provide flexibility and be adaptable to specific dispensing location requirements. The product dispensing system 120 may further include a second product height profile to provide an alternate scheduling regime. Illustratively, the product dispenser 100 may comprise a weekday schedule and a weekend schedule to accommodate varying peak loading situations.

The product generator 110 may be any form of product generation, or any form of transfer and containment system that is coupled to a product supply. Illustratively, the product generator 110 may be an icemaker, a rock crusher, a pebble grinder, or a hopper for storing items such as ice, pebbles, grain, peanuts, or the like. In this extension of the first embodiment, the product generator 110 is an icemaker that includes at least one outlet 111. The product generator 110 may be remotely located or may be located adjacent to the product dispenser 100. If the product generator 110 is remotely located, then the term product generator may further include a delivery apparatus, such that the product generator 110 ultimately delivers a product to the product dispenser 100 through the port 103.

On assembly of the product dispenser 100, a desired number of product level determiners 160 through 162 may be aligned or positioned within the storage chamber 102, or may be subsequently secured to the zone aperture pairs 148, 149, and 150. Once positioned correctly within a respective zone aperture pair 148, 149, or 150, respective emitters may transmit light to a correctly positioned detector disposed within the opposite aperture when the light emitting diodes are powered. The detecting diodes may then receive the transmitted light in cases where the light path is unobstructed. Assembly of the product dispenser 100 continues with the mounting of the driver 106 onto the front of product dispenser 100, such that the output shaft of the driver 106 passes through the driver port 115, thereby gaining access to the storage chamber 102. The assembly process continues with the installation of the paddlewheel 104 into the storage chamber 102, such that the central aperture of the paddlewheel 104 is mounted to the output shaft of the driver 106. Once the paddlewheel 104 is correctly positioned and secured, the agitator 105 may be inserted into the storage chamber 102 such that the first end 135 of the agitator 105 is secured to either the paddlewheel 104 or the output shaft of the driver 106, and the second end 136 is secured to the support point on the rear wall 138 of the storage chamber 102. Once correctly secured, the agitator 105 and the paddlewheel 104 will rotate with the output shaft 116 of the driver 106. When correctly installed, the agitator 105 may fully rotate within the storage chamber 102. Should a product be disposed within the storage chamber 102, the agitator 105 will move through the product to reset the product.

On further assembly, the controller 125 may be mounted to the housing 101, and the first, second and third zone harnesses 152, 153, and 154 may be connected to the input lead 140, such that electrical signals may be communicated to the controller 125 during operation. The buildup of the product dispenser 100 continues with the installation of the actuator 112, the activation switch 157, and the connection of the input lead 144 to the activation switch 157. As such, the controller 125 may recognize when the actuator 112 has be actuated by a user and may calculate the amount of product dispensed.

The product generator 110 or extension thereof may then be placed atop of the product dispenser 100 such that the at least one outlet 111 is located above the port 103 of the storage chamber 102. The output lead 141 of the controller 125 may then be connected to the product generator 110, such that the controller 125 delivers signals to the product generator 110 through the output lead 141.

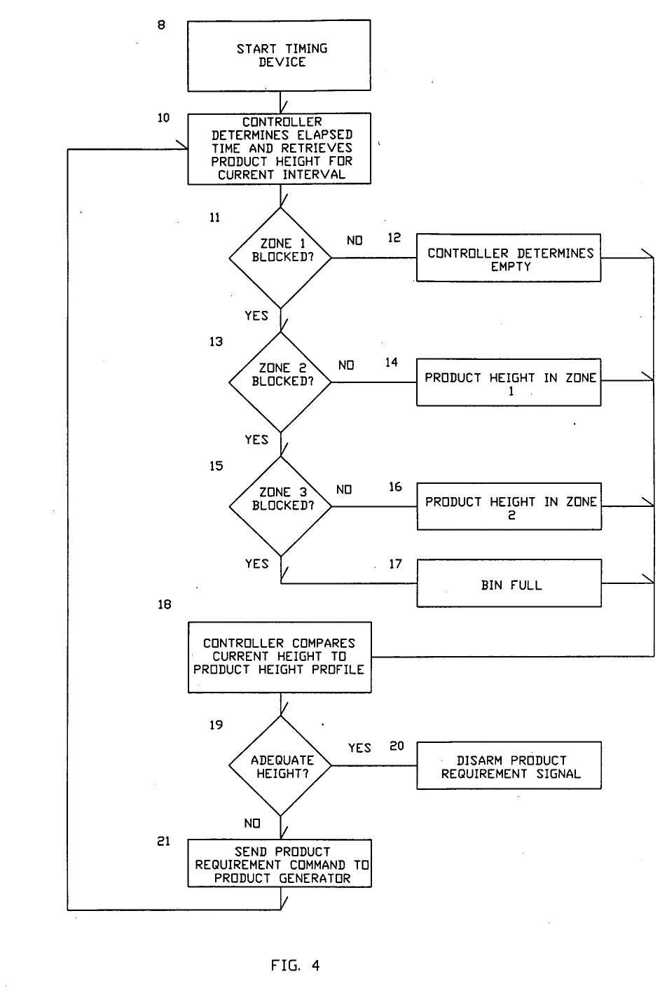

In operation, the product generator 110 creates product and drops the product through the port 103 in the storage chamber 102 when demanded by the controller 125. As shown in the method flowchart of FIG. 4, the process commences with step 8, wherein the timing device commences a timing sequence. In step 10, the controller 125 determines an elapsed time and retrieves a desired product height for the current interval. The process then moves to step 11, wherein the controller 125 commences a process to determine a current product height disposed within the storage chamber 102. As shown in step 11, the controller 125 determines if the LED light path between the first zone product level determiners 160 is blocked. If the light path for the first zone product determiners 160 is blocked, the controller 125 moves to step 12 and determines that the storage chamber 102 product level is at least below the level of the first zone product determiners 160. If the light path between the first zone product determiners 160 is blocked by the product disposed within the product chamber 102, then the controller 125 moves to step 13, wherein it determines if the light path between the second zone product determiners 161 is blocked. If the light path between the second zone product determiners 161 is not blocked, then the controller 125 moves to step 14, and determines that the product height is at a level between the first zone product determiners 160 and the second zone product determiners 161. If the light path between the zone two product determiners 161 is blocked in step 13, the controller 125 moves to step 15, wherein it determines if the light path between the zone three product determiners 162 is blocked. If the light path between the third zone product determiners 162 is not blocked, the controller 125 moves to step 16, wherein it determines the level of the product disposed within the storage chamber 102 is between the level of the zone two product determiners 161 and the zone three product determiners 162. If the light path between the third zone product determiners 162 is blocked in step 15, the controller 125 moves to step 17, wherein the controller 125 determines that the level of the product disposed within the storage chamber 102 is at or above the third zone product determiners 162. Once a current product height has been determined, the controller 125 moves to step 18, wherein the controller 125 compares the current product height to the desired product height for the current time interval. The controller 125 must then move to step 19 to determine if the product height in the storage chamber is above or below the product height profile requirement. If the current product height is equal to or above the required product height the process moves to step 20, wherein the controller 125 disarms the product height requirement signal being delivered to the product generator 110. If there is not an adequate product level in step 19, then the controller 125 moves to step 21, wherein the controller 125 sends a signal that activates the product generator 110. The controller 125 then moves to step 10 at a predetermined interval to update the product height profile. Accordingly, the process may run continuously to maintain a predetermined level of product in the storage chamber 102 at any time interval.

In use, the product generator 110 produces a product when a requirement signal is delivered from the controller 125 of the product dispenser 100 to the product generator 110. The produced product is deposited into a storage chamber 102 until portioned for use. Upon an operator depressing an actuator 112, or other form of activation means, the driver 106 rotates the paddlewheel 104 and the agitator 105 to segment and deliver a portion of the product disposed within the storage chamber 102 through the dispensing port 107 to the chute 108, and into an operator's receptacle. Illustratively, the product may be ice, or any other product in the form of a particulate. As the product disposed within the storage chamber 102 melts or is consumed, the level of product will continue to decline. The controller 125 routinely checks the level of the product in the storage chamber 102, and compares the current product level to desired product height for a current interval of the product height profile. If adequate product exists within the storage chamber 102 for the current time interval, the controller 125 does not send a product requirement signal to the product generator 110. However, if the product level is below the predetermined threshold, the controller 125 sends a product requirement signal to the product generator 110. The product requirement signal remains on until a sufficient product level has been achieved. At that point, the controller 125 disarms the product requirement signal. As such, the controller 125 updates the product height requirement periodically, and then compares the current product level to the current product height requirement to determine if additional product is required. Accordingly, the product dispensing system 120 should continuously be working to maintain a product level consistent with the product height profile.

While this first embodiment has been shown with wiring harnesses, one of ordinary skill in the art will recognize that virtually any form of electrical connection may be utilized, including radio-frequency communication, and the like.

In a second embodiment, a product dispensing system 220 includes a product dispenser 200 and a product generator 110 disposed on top of the product dispenser 200. The product dispenser 200 and the product generator 110 are identical to the product dispenser 100 and the product generator 110 of the first embodiment, and like parts have been annotated with like numerals; however, the product dispenser 200 does not include a separate timing device 143, and a controller 225 of the product dispenser 200 further includes a real-time clocking mechanism and an internal data bank. As one of ordinary skill in the art will recognize, the real-time clocking mechanism provides the controller 225 with the capability to conduct scheduling routines based on real-time timing data. The internal data bank of the controller 225 may be any form of memory storage, including random access memory, flash memory, or the like, wherein data for a product height profile may be stored and accessed as required by the controller 225.

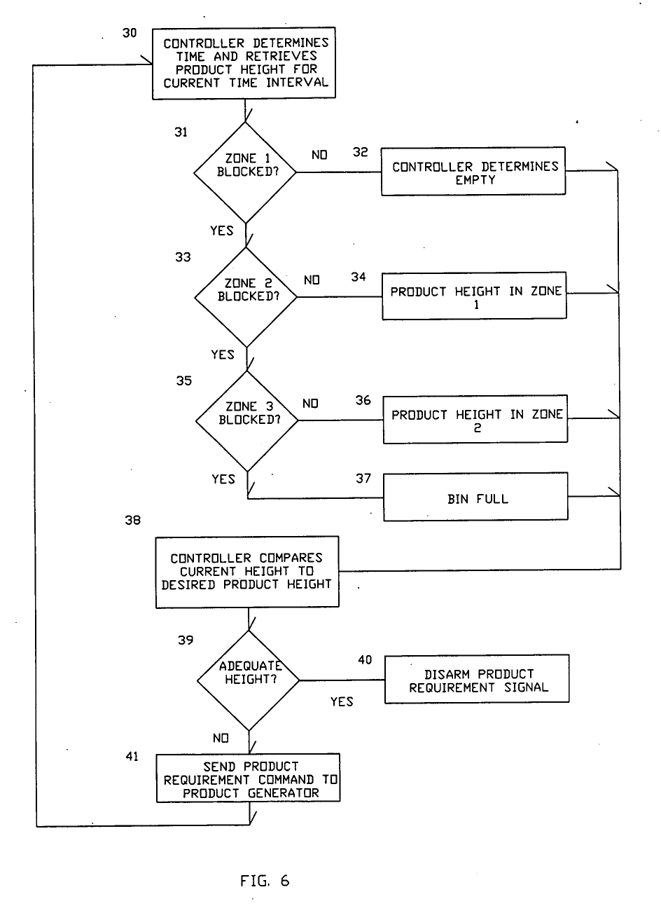

Operation of the product dispensing system 220 is similar to the first embodiment; however, the controller 225 now conducts virtually all timing operations. As shown in the method flowchart of FIG. 6, operation of the product dispensing system 220 commences with step 30, wherein the controller 225 determines the current time and retrieves desired product height information for the current time interval, as dictated by product height requirement profile. Once the appropriate height requirement of the product height profile has been selected, the controller 225 moves to step 31 to commence the determination of the current level of a product disposed within the storage chamber 102. As shown is step 31, the controller 225 determines if the LED light path between the first zone product level determiners 160 is blocked. If the light path for the first zone product determiners 160 is not blocked, the controller 225 moves to step 32 and determines that the storage chamber 102 product level is at least below the level of the first zone product determiners 160.

If the light path between the first zone product determiners 160 is blocked by the product disposed within the product chamber 102, then the controller 225 moves to step 33, wherein it determines if the light path between the second zone product determiners 161 is blocked. If the light path between the second zone product determiners 161 is not blocked, then the controller 225 moves to step 34, and determines that the product height is at a level between the first zone product determiners 160 and the second zone product determiners 161. If the light path between the second zone product determiners 161 is blocked in step 33, the controller 225 moves to step 35, wherein it determines if the light path between the third zone product determiners 162 is blocked. If the light path between the third zone product determiners 162 is not blocked, the controller 225 moves to step 36, wherein it determines the level of the product disposed within the storage chamber 102 is between the level of the second zone product determiners 161 and the third zone product determiners 162. If the light path between the third zone product determiners 162 is blocked in step 35, the controller 225 moves to step 37, wherein the controller 225 determines that the level of the product disposed within the storage chamber 102 is at or above the third zone product determiners 162.

Once a current product height has been determined, the controller 225 moves to step 38, wherein the controller 225 compares the current product height to the desired product height for the current time interval. The controller 225 must then move to step 39 to determine if the product height in the storage chamber 102 is above or below the product height profile requirement. If the current product height is equal to or above the current product height requirement of the product height profile, then the process moves to step 40, wherein the controller 225 disarms the product height requirement signal being delivered to the product generator 110. If there is not an adequate product level in step 39, then the controller 225 moves to step 41, wherein the controller 225 continues to send a product requirement signal to the product generator 110. The process then moves to step 30 at a predetermined interval to update the time and the desired product height for the current interval. Accordingly, the process may run continuously to maintain a predetermined level of product in the storage chamber 102 at any time interval.

Utilization of the product dispensing system 220 is substantially identical to the use of the product dispensing system 120, and therefore, will not be further described.

In an extension of the second embodiment, the product dispensing system 220 may further include a self-monitoring function that allows the controller 225 to override the predetermined product height profile programming when an observed usage during an elapsed portion of the current product height profile interval projected over the remaining portion of the current product height profile interval is greater than the actual level of product in the storage chamber 102. In this extension of the second embodiment, the controller 225 monitors dispensing and determines the total amount of product dispensed during the elapsed portion of the current product height profile interval, and divides the amount of dispensed product by the elapsed time of the current product height profile interval to derive a usage rate for the current interval. The controller 225 then projects the derived usage rate over the time remaining in the current product height profile interval through multiplying the usage rate by the time remaining in the current interval to determine a projected product requirement for the time remaining in the interval. The controller 225 then compares the projected product requirement to the actual level of product to determine if adequate product exists within the storage chamber 102.

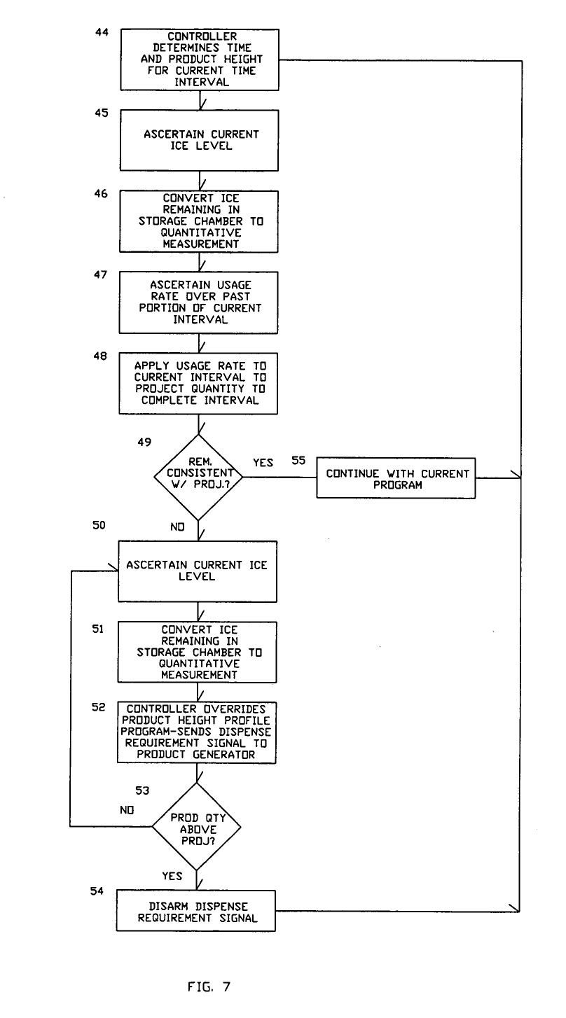

As shown in the method flowchart of FIG. 7, the process commences with step 44, wherein the controller 225 determines the time and retrieves a required product height for the current interval. The controller 225 then moves to step 45, wherein it derives the current product level in the storage chamber 102 utilizing the process disclosed in steps 31-37 of the method flowchart of FIG. 6, or other suitable method. Once a product level has been derived, the controller 225 may convert the product height information to a quantity estimate of the amount of ice remaining in the storage chamber 102, as shown in step 46. Illustratively, a data table may be in place to relate the product height information to a quantitative measurement. In this example, the quantitative measurement is weight. The controller 225 then moves to step 47 to calculate a usage rate for the elapsed portion of the current product height profile interval by dividing the amount of product dispensed during the elapsed time. Once the usage rate is calculated, the controller 225 multiplies the derived usage rate to the amount of time remaining in the current product height profile interval to project a quantity of product required to complete the current interval, step 48. After all data points are secured, the controller 225 moves to step 49, where it determines if the projected product requirement is consistent with the quantity of product remaining in the storage chamber 102. If the quantity of product in the storage chamber 102 is greater than the projected product requirement, the controller 225 moves to step 55, to continue with current programming. If the amount of product in the storage chamber 102 is not sufficient to cover the time remaining in the current interval in step 49, the controller 225 moves to step 50, wherein it overrides the product height profile interval programming, and sends a dispense requirement signal to the product generator 110. Once the dispense requirement signal has been sent to product generator 110, the controller 225 moves to step 51 to recalculate the product height. The controller 225 then moves to step 52 to convert the product height to a product quantity. The controller 225 then moves to step 53 to determine if the new product quantity is greater than the projected product quantity. If the level of product in the storage chamber 102 is not adequate for the time remaining in the period, the controller 225 returns to step 50 to calculate a new product height, and a signal to the product generator 110. If the product height is above the amount required to sustain the remainder of the interval, then the controller 225 moves to step 54, wherein it disarms the dispense requirement signal. The controller 225 then returns to step 44 to further update the time and the desired product height for the current interval.

In a second extension of this second embodiment, a controller 225 may include programming that provides for recording usage patterns and creating product requirement profiles based upon the usage patterns. One of ordinary skill in the art will recognize that this form of operation may be referred to as “teach and learn.” All structure of this second extension of the second embodiment may be identical to the first extension of the second embodiment, and like parts may be referenced with like numerals. The controller 225 may be identical to the controller of the second embodiment, however, the controller 225 now further includes memory storage devices, as well as any additional hardware associated with the additional “teach and learn” programs.

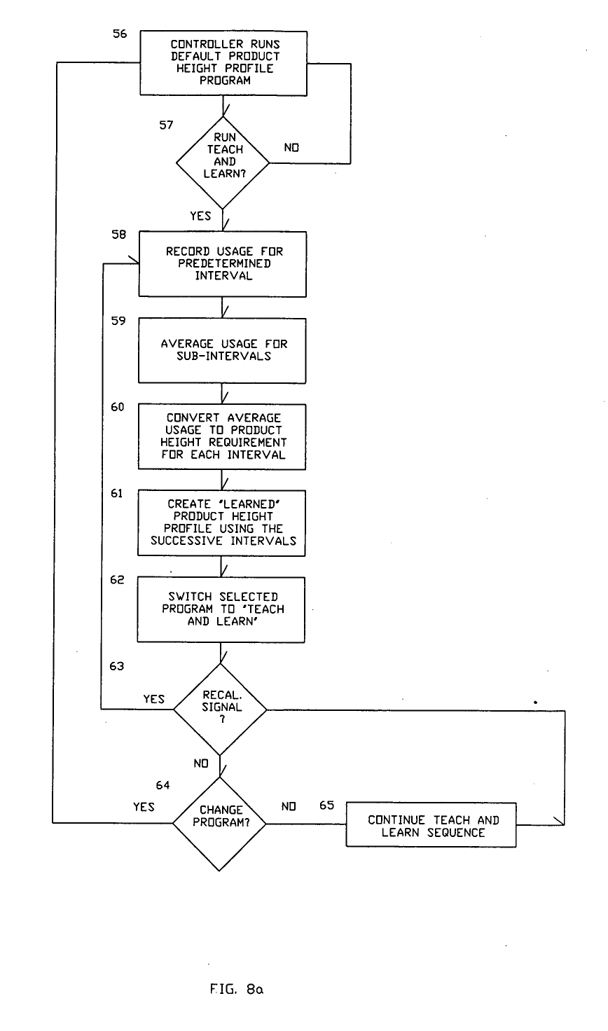

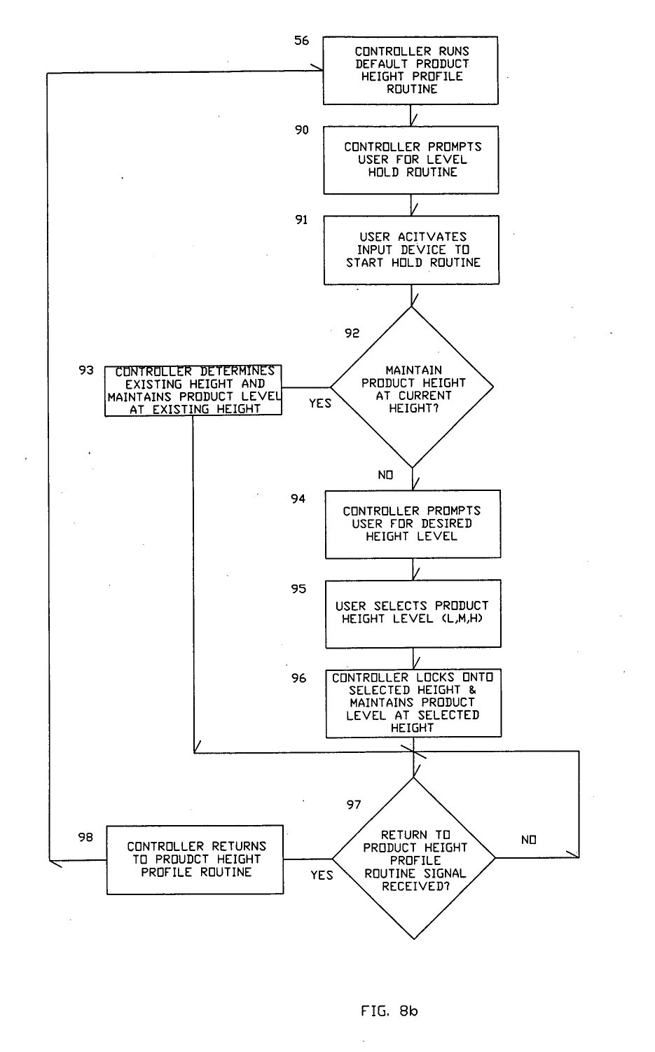

The method flowchart of FIG. 8a demonstrates one possible process associated with a “teach and learn” type program. As illustrated in step 56, the controller 225 may initially utilize a default program or one preset by an operator or the dispenser manufacturer. The controller 225 then prompts an operator for a “teach and learn” command as shown in step 57. If the operator does not choose to run a “teach and learn” command, the controller 225 returns to step 56 to continue to run the default program. If the operator chooses to run the “teach and learn” program in step 57, the controller 225 moves to step 58, wherein it records usage for a predetermined interval. Illustratively, the controller 225 may record dispensing operations for a twenty-four hour period. Once the predetermined record interval has elapsed, the controller 225 averages the usage for predetermined increments of the recording period. For example, the controller 225 could average the usage based on one-hour increments of the twenty-four hour periods, step 59. In step 60, the controller 225 converts the recorded usage amounts to required product heights for each interval by dividing the usage amounts (lbs.) by the density of ice to generate a volumetric measurement (cu. ft.). The controller 225 then multiplies the volumetric measurement by a packing efficiency for a particular cube size to generate required volume. As disclosed in previous embodiments, the product volume measurements for a given product height are known for the storage chamber 102 being utilized, and may be referenced to derive a required product height. One of ordinary skill in the art will recognize that a conversion table may be created by manually placing ice into the storage chamber 102, recording height measurements, and storing the data. Accordingly, once a required volume is derived for each product height profile interval, a corresponding required product height can be derived. Step 61 provides for creating a “learned” product height profile using the averaged usage amounts for each of the sub-intervals.

Once the “learned” product height profile has been created, the controller 225 switches the selected programming to the “teach and learn” program, step 62, wherein the product height requirements are the “teach and learn” averaged usage amounts. The product dispensing system 220 continues to operate in the “teach and learn” mode. Once in the “teach and learn” mode, the controller 225 moves to step 63 to determine if a recalibration signal has been received. A recalibration may be forced by the operator or may be scheduled for a certain interval. If in step 63 a recalibration signal is received, the controller 225 returns to step 58 to recommence the recording phase. Alternatively, the controller 225 may recalibrate the “teach and learn” sequence after a predetermined period, daily for example. The controller 225 may recalibrate the derived usages over longer periods of time, weekly for example. If a recalibration signal is not received in step 63, the controller 225 moves to step 64 to determine if a program change is required. The “teach and learn” program may continue to run until a prompt is received from an operator to change the program setting as shown in step 64. If the operator desires a program change in step 64, the controller returns to step 56, wherein it sets the default program as the program selected. If the operator does not request a program change, the controller 225 moves to step 65 and continues to run the “teach and learn” program. The controller 225 then moves to step 63 to determine if a recalibration input has been received. One of ordinary skill in the art will recognize that a real-time clock would be beneficial in a “teach and learn” program environment.

In this disclosure, the “teach and learn” capability is applicable to virtually all measurable values and system parameters to monitor, assess, and redirect the system parameters based on the learned information. Illustratively, parameters include, but are not limited to, beverage dispenses, ice dispenses, the product height, a cold plate temperature, a water inlet temperature, and ambient air temperature, and the like. Accordingly, an “account profile” may be created for use in monitoring product usages, product volumes, and product dispenser operations, as well as to derive product dispenser expectations.

In a third extension of the second embodiment, the product supply management system includes the capability to hold the level of product in the storage chamber at a desired level. All structure of this third extension of the second embodiment may be identical to the first and second extensions of the second embodiment, and like parts may be referenced with like numerals. The controller 225 may be identical to the controller of the second embodiment, however, the controller 225 now further includes memory storage devices, as well as any additional hardware associated with the additional “level hold” programs.

In this third extension of the second embodiment, controller 225 defaults to the product height profile program as described in the second embodiment, wherein the product supply management system includes the ability to determine a height of a product disposed within the storage chamber 102. This third extension of the second embodiment further requires an input device, such as a button or an on-screen display window, wherein a user is able to deliver input to the controller 225 by touching a particular area of the screen. The “level hold” program allows a user to maintain an existing height or to select a product height or zone dependent upon the product height measuring techniques. Illustratively, an incremental height in the vertical direction may be broken into a plurality of segments, including, but not limited to, low, med, and high, zones based on incremental segments, and zones based upon desired weights of products disposed within the storage chamber.

FIG. 8b provides a method flowchart illustrating the method steps of utilizing the “level hold” program. The process commences with step 56, wherein the controller 225 conducts a default product height profile routine as described in the previous embodiments. The controller 225 prompts a user for instruction to conduct a “level hold” routine, step 90. The user then activates the input device to start the “level hold” routine, step 91. The controller 225 then prompts the user to determine whether the controller 225 will be maintaining the product level at a current height, step 92. If the current height is not to be maintained in step 92, the controller 225 moves to step 94, wherein the controller 225 prompts the user for a desired height level. The controller 225 then moves to step 95 wherein the user selects a product height level. In step 96, the controller 225 locks onto the selected height and maintains the selected product height in the storage chamber. In step 97, the controller 225 determines if a return to product height profile routine has been received. If the return to product height profile routine signal has not been received, the controller 225 returns to a point between steps 96 and 97. If a return to product height profile routine signal has been received in step 97, the controller 225 moves to step 98, wherein the controller 225 returns the current programming to the product height profile routine, and then moves to step 56 to conduct the product height profile routine.

If the current product height is going to be maintained in step 92, the controller 225 moves to step 93, wherein the controller 225 determines the existing height and maintains the current product height. The controller 225 then moves to step 97 to determine if the return to product height profile routine signal has been received. If a return to product height profile routine signal has been received in step 97, the controller 225 moves to step 98, wherein the controller 225 returns the current programming to the product height profile routine, and then moves to step 56 to conduct the product height profile routine.

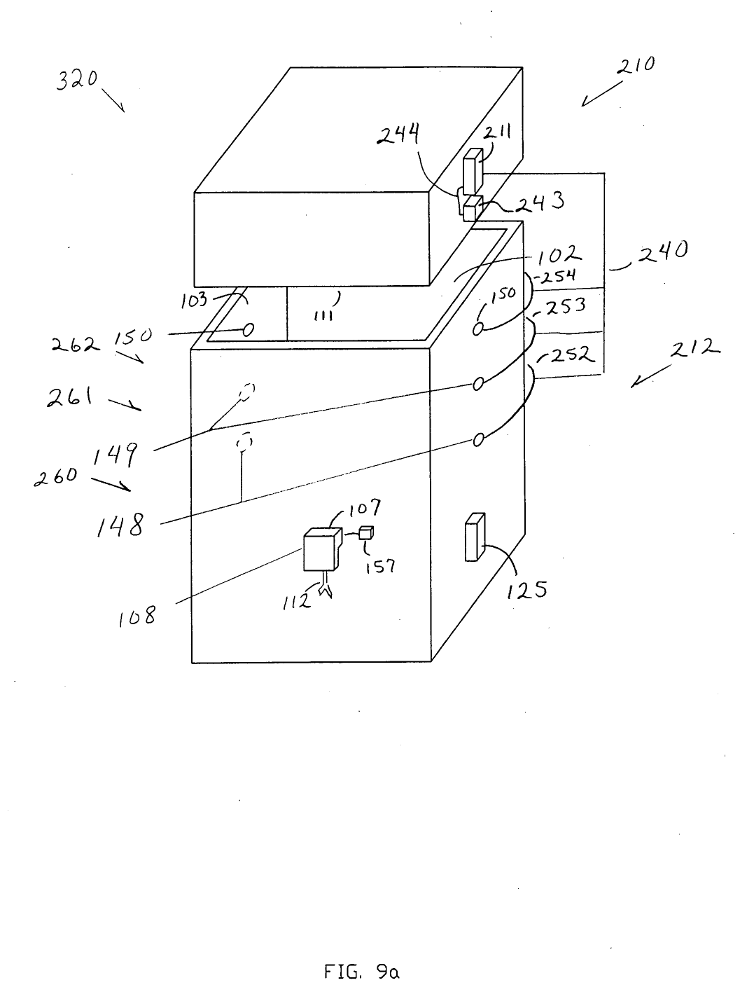

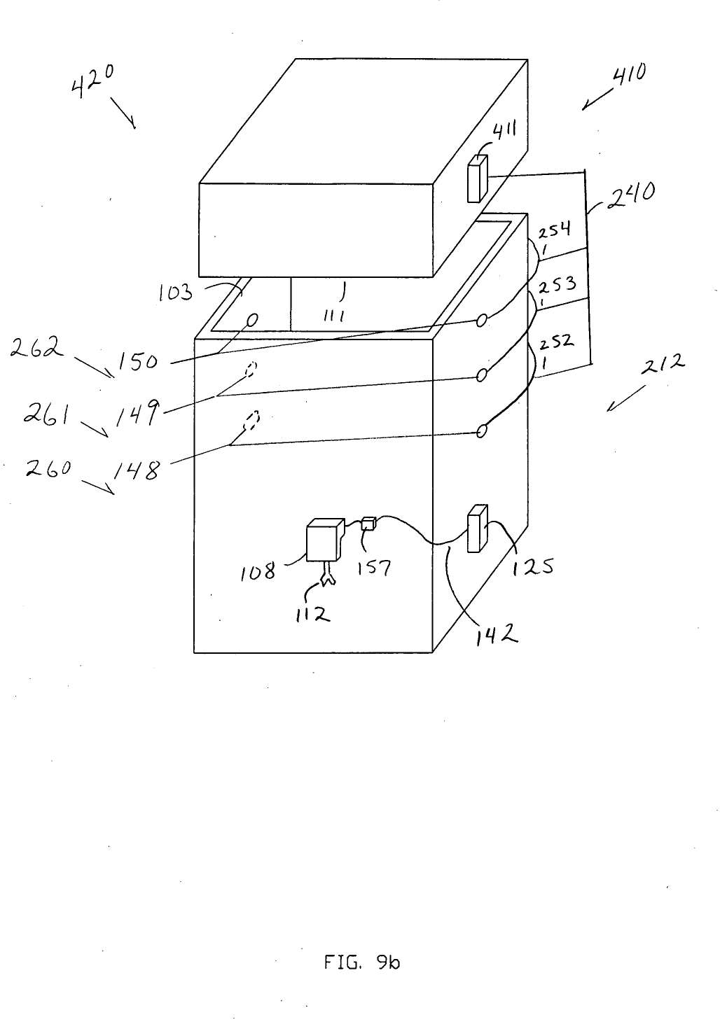

In a third embodiment, a product generator including a controller is disposed atop a product dispenser, and is able to ascertain a height of a product disposed within a storage chamber of the product dispenser. As shown in FIG. 9a, a product dispensing system 320 includes a product dispenser 212 and a product generator 210. The product dispenser 212 is similar in construction to the product dispensers 100 and 200, and like parts have been labeled with like numerals, however, the product dispenser 212 does not include a product height profile, and the controller 125 or 225 is not in communication with an input harness coupled to a product level determiner. The product dispenser 212 retains a controller 125 or 225 to conduct dispensing operations.

The product dispenser 212 includes a storage chamber 102, a first zone aperture pair 148, a second zone aperture pair 149, and a third zone aperture pair 150, that are identical to the product dispensers 100 and 200. The product dispenser 212 further includes a dispensing port 107 disposed within the storage chamber 102, a paddlewheel, an agitator, a driver 106, a dispensing chute 108 coupled to the dispensing port 107, and an actuator 112 coupled to an activation switch 157. A product may be stored within the storage chamber 102, moved to the dispensing port 107 by the paddlewheel, and dispensed through the dispensing chute 108. Illustratively, ice may be stored within the storage chamber 102.

The product generator 210 includes a controller 211, a timing device 243, a first zone product determiner 260, a second zone product determiner 261, a third zone product determiner 262, an input harness 240, a first zone harness 252, a second zone harness 253, and a third zone harness 254. In this embodiment, the input harness 240 is in electrical communication with the controller 211, and the product level determiners 260, 261, and 262. The controller 211 is in further electrical communication with the timing device 243 through an input lead 244, such that the controller 211 receives information from the timing device 243. The input harness 240 is further in electrical communication with the first zone harness 252, the second zone harness 253, and the third zone harness 254, such that electrical signals may be conducted from the zone harnesses 252, 253, and 254, to the controller 211 through the input harness 240. The zone harnesses 252, 253, and 254, are in electrical communication with the product level determiners 260 to 262, such that the product level determiners 260 to 262 are in electrical communication with the controller 211.

On assembly, the product generator 210 is disposed atop the product dispenser 212. The input harness 240 extends downward to the product dispenser 212, and the product level determiners 260 are attached to the first zone harness 252. The first zone product determiners 260 are secured in the first zone aperture pair 148 of the product dispenser 212, such that the product level determiners 260 may send signals to each other through the storage chamber 102. Similarly, the second zone product determiners 261 are attached to the second zone harness 253 are placed into the second zone aperture pair 149, and the third zone product determiners 262 are attached to the third zone harness 254 are placed into the third zone aperture pair 150.

Operation of the product dispensing system 320 is substantially identical to the operation of the product dispensing system 120, however, the operations involved in the determination of the product level, and the product requirements are conducted by the controller 211, which is disposed within the product generator 210. In this configuration, the product generator 210 is a “master,” and the product dispenser 212 acts as a “slave” device in that the product dispenser 212 awaits and receives instructions from the product generator 210. As the control routine is substantially identical to the product dispensing system 120, operation of the product dispensing system 320 is identical to the method flow chart presented in FIG. 4, wherein the controller 211 starts the timing device 243, determines an elapsed time, and retrieves a product height requirement for the current interval. The controller 211 then determines a level of product disposed within the storage chamber, compares the data points, determines whether more product needs to be generated, and then arms or disarms a dispense requirement signal.

In a fourth embodiment, a product dispensing system 420 includes a product generator 410 and a product dispenser 212. As shown in FIG. 9b, the product dispensing system 420 is similar to the product dispensing system 320, and accordingly, like parts have been labeled with like numerals. The product generator 410 is similar to the product generator 210, however, the product generator 410 includes a real-time clocking mechanism and an internal data bank. As one of ordinary skill in the art will recognize, the real-time clocking mechanism provides a controller 411 with the capability to conduct scheduling routines based on real-time timing data. The internal data bank of the controller 411 may be any form of memory storage, wherein data for a product height profile may be stored and accessed as required by the controller 411.

Operation of the product dispensing system 420 is substantially identical to the operation of the product dispensing system 220, however, the operations involved in the determination of the product level, and the product height requirements are conducted by the controller 411, which is disposed within the product generator 410. Accordingly, the method of operation for the product dispensing system 420 follows the method flow chart of FIG. 6, wherein the controller 411 determines the time and retrieves product height information for the current interval. The controller 411 then determines a level of product disposed within the storage chamber, compares the data points, determines whether more product needs to be generated, and then continues or disarms a dispense requirement signal.

In an extension of the fourth embodiment, the product dispensing system 420 may further include a self-monitoring function that allows the controller 411 to override the predetermined product height profile programming when an observed usage during an elapsed portion of the current product height profile interval projected over the remaining portion of the current product height profile interval is greater than the actual level of product in the storage chamber 102. In this extension of the fourth embodiment, the controller 411 monitors the amount of product dispensed during the current product height profile interval, and divides the amount of dispensed product by the elapsed time of the current product height profile interval to derive a usage rate for the current interval. The controller 411 then projects the derived usage rate over the time remaining in the current product height profile interval through multiplying the usage rate by the time remaining in the current interval to determine a projected product requirement for the time remaining in the interval. The controller 411 then compares the projected product requirement to the actual level of product to determine if adequate product exists within the storage chamber 102.

Operation of the product dispensing system 420 in this extension of the fourth embodiment is substantially identical to the first extension of the second embodiment, however, the operations involved in the determination of the product level and the product requirements are conducted by the controller 411, which is disposed within the product generator 410. Accordingly, the method of operation for the product dispensing system 420 follows the method flow chart of FIG. 7, wherein the controller 411 determines the time and retrieves product height information for the current interval. The controller 411 then determines a level of product disposed within the storage chamber, converts the ice level to a quantitative value, calculates a usage rate over a past portion of a current interval, applies the usage rate over the remaining portion of the current interval, and determines whether the actual product height is greater than the projected product height. If the controller 411 determines that the remaining product height is not adequate, then the controller 411 overrides the current program to ensure adequate product height.

In a second extension of the fourth embodiment, a controller 411 includes programming that provides for recording usage patterns and creating product requirement profiles based upon usage patterns. One of ordinary skill in the art will recognize that this form of operation may be referred to as “teach and learn.” All structure of this second extension of the fourth embodiment may be identical to the first extension of the fourth embodiment, and like parts may be referenced with like numerals. The controller 411 may be identical to the controller 225, however, the controller 411 is now disposed on the product generator 410, and may further include memory storage devices, as well as any additional hardware associated with the additional “teach and learn” programs.

Operation of this second extension of the fourth embodiment is substantially identical to the second extension of the second embodiment, however, the operations involved in the determination of the product levels, and the product requirements are conducted by the controller 411 that is disposed within the product generator 410. Accordingly, the method of operation for the product dispensing system 420 follows the method flow chart of FIG. 8a, wherein the controller 411 runs a default product height profile program for a current time interval, awaits a “teach and learn” command, records usage for a predetermined interval, averages the usage over sub-intervals, and creates a “learned” product height profile program that utilizes the derived usage patterns. In this manner, the controller 411 creates a schedule based on usage rates for different time intervals. The controller 411 may recalculate usages after a predetermined interval to further update the created “teach and learn” schedule.

While this second extension of the fourth embodiment has been shown with a “teach and learn” capability, one of ordinary skill in the art will recognize that the “teach and learn” capability is applicable to virtually all measurable values, including product dispenses, ice dispenses, the product height, a cold plate temperature, a water inlet temperature, ambient air temperature, and the like. One of ordinary skill in the art will further recognize that an “account profile” may be created for use in monitoring product usage volumes, product dispenser operations, as well as to derive product dispenser expectations.

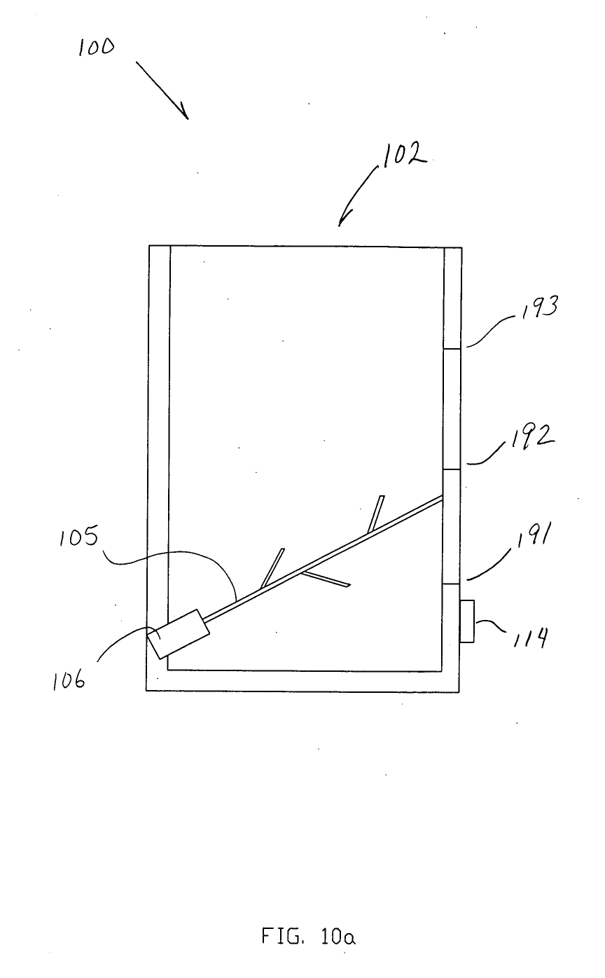

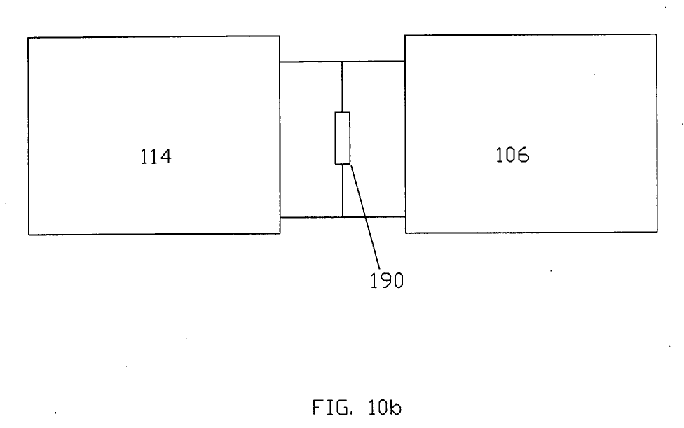

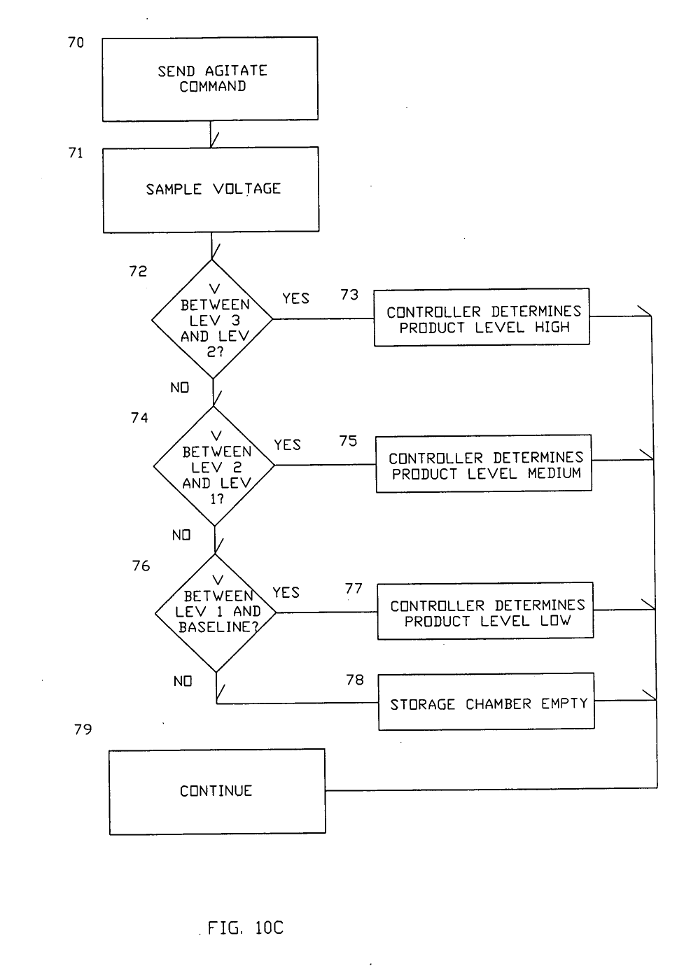

Alternatively, the determination of a product level disposed in a storage chamber 102 in any of the previous embodiments may also be ascertained by monitoring a voltage applied to a driver 106 that rotates the agitator 105 disposed inside of the storage chamber 102. As shown in FIG. 10a, this scheme may be accomplished by placing a resistor 190 across the terminals of the driver 106. In this embodiment, the driver 106 is an electric motor. The voltage may be amplified to expand any deltas, and the controller 114 then monitors the amplified voltage across the resistor 190. The measured voltages are then compared to a data profile of voltages associated with moving the agitator 105 through varying levels of a product. Illustratively, a baseline voltage may be recorded for an empty condition, and voltage would increase as the product level in the storage chamber 102 increased. One of ordinary skill in the art will recognize that virtually any data point in a vertical column may utilized to create the data profile. One of ordinary skill in the art will further recognize that zones may be created to represent product levels between preselected points. Illustratively, a first point 191 may be designated as a highest point for a “low” level, a higher second point 192 may be designated as a highest point for a “medium” level, and a third point 193 at the top of the storage chamber 102 may be designated a highest point for a “high” level. The process provides for determination of a product level within the storage chamber 102. One of ordinary skill in the art will further recognize that the steps involved in determining the product level in the previous embodiments may be utilized in combination with the voltage sensing arrangement as described herein.

Operation of the product level sensing system according to this embodiment is shown in the method flowchart of FIG. 10c. The process commences with step 70, wherein the controller 114 sends an agitate command to the driver 106. During the agitation sequence, the controller 114 samples the voltage across the resistor 190, step 71. Step 72 calls for the controller 114 to determine if the sample voltage is between the second point 192 and the third point 193. If the sample voltage is between the second point 192 and the third point 193, then the controller 114 moves to step 73 and determines that the product level is in a “high” condition. If the controller 114 determines that the product level is not between the second point 192 and the third point 193, then the controller 114 moves to step 74, wherein it determines if the voltage is between the first point 191 and the second point 192. If the voltage is between the first point 191 and the second point 192 in step 74, the controller 114 moves to step 75, wherein it determines that the product level is in a “medium” condition. If the controller 114 determines that the sample voltage is not between the first point 191 and the second point 192 in step 74, then the controller 114 advances to step 76, to determine if the sample voltage is between the first point 191 and the baseline voltage. If the sample voltage is between the first point 191 and the baseline voltage, the controller 114 moves to step 77, wherein it determines the product level is in a “low” condition. If the sample voltage is not between the first point 191 and the baseline voltage in step 76, the controller 114 moves to step 78, wherein it determines that the storage chamber 102 is empty. After determination of a product level, the controller 114 moves to step 79, and may transition into any of the previous methods utilizing a product level determination sequence.

While the previous embodiments have been shown with product height profile having definite transition points, one of ordinary skill in the art will recognize that the product height profile may include gradual transitions in the product height profile such that product generator has sufficient time to build up product levels before an anticipated rush.

In a sixth embodiment, a product supply management system 500 is similar in form and function to the product supply management systems according to the previous embodiments, however, the product supply management system 500 utilizes system parameters to derive the amount of ice remaining in the storage chamber 102. A controller 114 of similar form and structure to the previous embodiments receives real-time environmental inputs 503 from sensors monitoring parameters of the product supply management system 500, and develops cumulative profiles 502 for the environmental inputs 503. Illustratively, the real-time environmental inputs 503 may include an ambient temperature, an incoming water temperature, a cold plate temperature, and the like. In this disclosure, the cumulative profiles 502 are defined as a cumulative measure over a preselected period of a product supply management system 500 parameter, including, but not limited to, ice production by the icemaker during a preselected period, amount of beverages dispensed during the preselected period, amount of ice dispensed during the preselected period, and the amount of melt water passing through the drain during the preselected period.

The controller determines an amount of ice produced by the product generator 101 by multiplying a known quantity of product per product drop by the number of drops. Illustratively, an icemaker may produce a number of pounds per drop, the controller 114 determines how many drops have occurred within the preselected period, and then multiplies the number of pounds per drop by the number of drops to get the product produced during the preselected period.

An amount of ice dispensed from the storage chamber may be approximated by applying a dispense rate over the preselected period. Illustratively, the controller 114 may ascertain how long an ice dispense actuator has been depressed. The dispense rate is then multiplied by the dispense time of the preselected period to create a dispensed ice quantity over the preselected period.

In this embodiment, a quantity of ice melted is directly measured at a discharge outlet. One of ordinary skill in the art will recognize that many forms of measuring a quantity of liquid flowing through a conduit are known in the art. Illustratively, a flowmeter may be utilized to deliver flow measurements to the controller 114. The controller 114 then converts the flow measurements to volumetric measurements. The volumetric measurements are then converted to an ice weight of a packing efficiency similar to the ice disposed within the storage chamber 101.

To derive an ice remaining amount, the controller 114 subtracts the amount of ice dispensed during the preselected period and the weight equivalent of the melted amount of ice from the ice produced amount for the preselected period. The ice remaining amount is then adjusted to compensate for environmental irregularities. For example, high ambient temperatures, excessive drinks dispensed, and other conditions that may affect a typical ice remaining calculation.

An environmental efficiency factor (E) is utilized to adjust the calculated numbers based on real-time environmental inputs and usage patterns during the preselected period. The amount of ice required to bring beverage fluids within temperature specifications varies with ambient temperatures. Higher ambient conditions place increased heat loads on the beverage dispensing system. The high temperature problem is further compounded by high usage patterns.

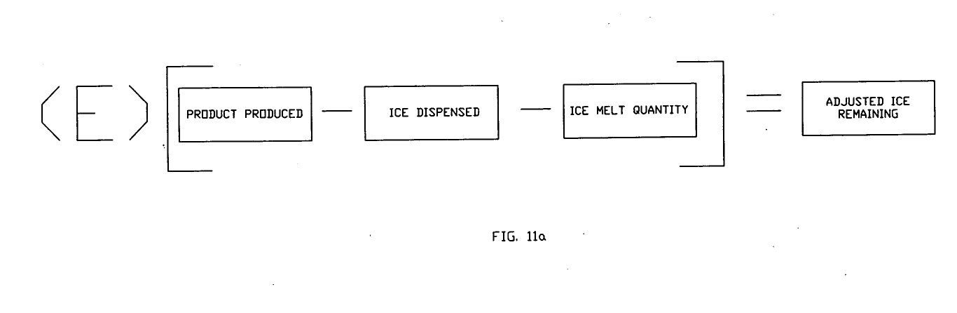

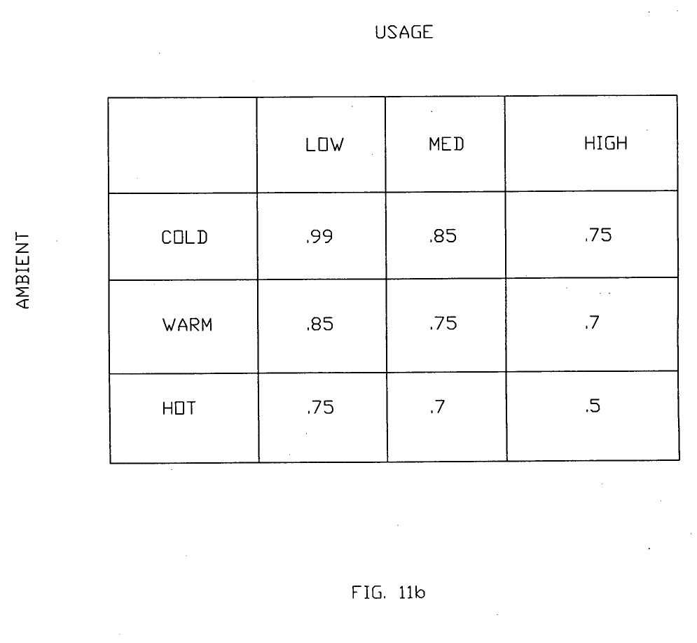

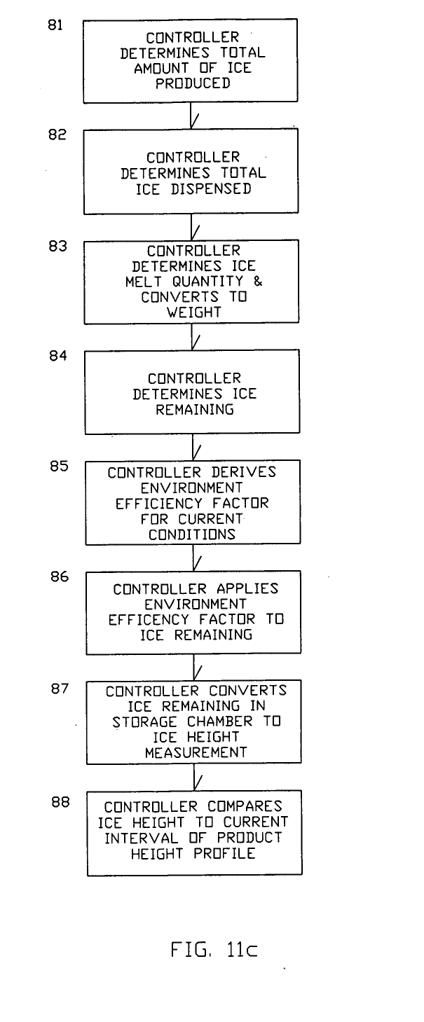

In this specific example, the environmental efficiency factor is a lookup table of ambient temperatures and associated burdens on a cold plate. As shown in FIG. 11b, the lookup table reflects virtually every condition of a temperature spread and a usage spread. One of ordinary skill in the art will recognize that the usage portion of the lookup table may be broken down into a low, a medium, and a high usage pattern. One of ordinary skill in the art will further recognize that ambient temperature conditions may range from below freezing to over a hundred degrees Fahrenheit, and may be broken into categories based on data. In this particular example, an ambient temperature under sixty degrees is considered cold, an ambient temperature between sixty and eighty degrees is considered warm, and ambient temperatures above eighty degrees are considered hot. Illustratively, approximately half of the ice in a storage chamber is utilized to cool a cold plate when dispensing a high amount of drinks in a tropical, sub-tropical, desert or otherwise hot weather climate. In a second example, a high usage rate in a cold environment consumes approximately twenty-five percent of the ice in the storage chamber 101.

As shown in FIG. 11a, the calculated amount of ice remaining is multiplied with the environmental efficiency factor to generate an adjusted ice remaining. The adjusted amount of ice remaining may then be converted to a product height measurement such that the controller 114 may compare the derived ice height to a product height profile as described in the previous embodiments.

FIG. 11c provides a flowchart illustrating the method steps utilized by the controller 114 in deriving a remaining ice height as described in this specific example. The process commences with step 81, wherein the controller 114 determines a total amount of ice produced by the product generator 101 within a preselected period. Next, the controller 114 determines a total amount of ice dispensed during the preselected period, step 82. The controller 114 then determines an ice melt quantity for the preselected period, and converts the volumetric measurement to a weight measurement, step 83. Step 84 provides for determining an amount of ice remaining by subtracting the ice dispensed and the ice melt quantity from the product dispensed. In step 85, the controller 114 derives an environmental efficiency factor for the current conditions. The controller 114 then applies the environmental efficiency factor to the ice remaining amount to get an adjusted ice remaining amount, step 86. In step 87, the controller 114 converts the calculated amount of ice remaining in the storage chamber 102 to an ice height in the storage chamber 102. In step 88, the controller 114 compares the ice height measurement to a current interval of a product height profile, as described in the previous embodiments.

While this example of the sixth embodiment has been shown with an environmental efficiency based on real-time environmental inputs and usage patterns, one of ordinary skill in the art will recognize that the real-time environmental inputs may be utilized separately, in combination with each other or with the cumulative inputs. It should be understood that many other factors or parameters may be utilized, separately or in combination, to calculate an ice remaining amount, such as the amount of beverages dispensed, ice produced, ice dispensed, ambient temperatures, incoming water temperatures, cold plate temperatures, and such parameters and resultant calculations are within the scope of this invention.

Although the present invention has been described in terms of the foregoing preferred embodiment, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing detailed description; rather, it is defined only by the claims that follow.

I claim:

1. A product supply management system, comprising:
a containment device including a storage chamber storing a product;
a product level determiner in communication with the storage chamber;
a product generator that delivers a product to the storage chamber; and
a controller in electrical communication with the product level determiner and the product generator, wherein the controller:
utilizes the product level determiner to determine a height of the product within the storage chamber,
compares the product height to a current interval for a product height profile, and
demands product from the product generator if the determined height of the product is less than the level dictated by the current interval of the product height profile, thereby raising the level of product to the level dictated by the product height profile.

2. The product supply management system according to claim 1, wherein the product level determiner determines the height of the product through direct measurement.

3. The product supply management system according to claim 1, wherein the product level determiner determines the height of the product through system parameters for a preselected period.

4. The product supply management system according to claim 1, wherein the controller sends a stop dispense command to the product generator when the determined product height is above the level required by the current interval of the product height profile, thereby ceasing the flow of product from the product generator to the storage chamber.

5. The product supply management system according to claim 1, further comprising a timing device, wherein the timing device executes a timing sequence.

6. The product supply management system according to claim 5, wherein the timing device is a mechanical timing device.

7. The product supply management system according to claim 6, wherein the mechanical timing device further delivers product height requirement data.

8. The product supply management system according to claim 1, wherein the controller includes a real-time clock to execute a timing sequence.

9. The product supply management system according to claim 5, wherein the product height profile includes multiple intervals, and further wherein the product height profile provides a desired product level for each interval.

10. The product supply management system according to claim 9, wherein the controller commences the product height profile in conjunction with a timing sequence of the timing device.

11. The product supply management system according to claim 9, wherein the product height profile is a data set.

12. The product supply management system according to claim 1, wherein the containment device is part of a product dispenser.

13. The product supply management system according to claim 12, wherein the product dispenser is an ice dispenser.

14. The product supply management system according to claim 13, wherein the ice dispenser is part of a beverage dispenser.

15. The product supply management system according to claim 12, wherein the controller is disposed within the product dispenser, thereby allowing the product dispenser to control the delivery of product from the product generator.

16. The product supply management system according to claim 1, wherein the controller utilizes a “teach and learn” sequence to build a product height schedule based on usage.

17. The product supply management system according to claim 9, wherein the controller may assess usage, project the usage over the remainder of a current interval, and override a product height profile program to ensure adequate product for the remainder of the current interval.

18. The product supply management system according to claim 1, wherein the controller is disposed within product generator.

19. The product supply management system according to claim 15, wherein the product height profile is based on a real-time schedule.

20. The product supply management system according to claim 1, wherein the product level determiner comprises:
an agitator disposed within the storage chamber to agitate the product; and
a driver coupled to the agitator that rotates the agitator to break up the product disposed within the storage chamber, wherein the controller is in electrical communication with the driver, and further wherein the controller samples the voltage across the driver and compares the voltage sample to a voltage load profile to determine a height of the product within the storage chamber.

21. The product supply management system according to claim 20, further comprising a shunt resistor in electrical communication with the controller and the driver, wherein a voltage across the resistor mirrors the voltage across the driver.

22. The product supply management system according to claim 1, wherein the product level determiner is an ultrasonic sensing system disposed on the containment device, wherein the ultrasonic sensing device delivers product height information to the controller.

23. The product supply management system according to claim 1, wherein the product level determiner is temperature sensing devices disposed at varying levels of the storage chamber, wherein the temperature sensing devices deliver product height information to the controller.

24. The product supply management system according to claim 1, wherein the product level determiner is an optical sensing system disposed on the containment device, wherein the optical sensing system components deliver optical signals across the storage chamber to determine if the product is blocking the optical signals.

25. The product supply management system according to claim 3, further comprising:
sensors that provide real-time environmental inputs to the controller.

26. The product supply management system according to claim 25, wherein the environmental input includes icemaker production.

27. The product supply management system according to claim 25, wherein the environmental input includes the quantity of beverage dispensed by the product dispenser during the preselected period.

28. The product supply management system according to claim 25, wherein the environmental input includes the quantity of ice dispensed by the product dispenser during the preselected period.

29. The product supply management system according to claim 25, wherein the environmental input includes the quantity of ice melt discharged by the product dispenser during the preselected period.

30. The product dispenser according to claim 25, wherein cumulative profiles of the environmental variables are created for the preselected period.

31. The product dispenser according to claim 25, further comprising:
an environmental efficiency factor to adjust calculated amounts based on the real-time inputs and usage patterns during the preselected period.

32. The product dispenser according to claim 31, wherein the environmental efficiency factor is a lookup table that provides efficiencies based on data.

33. A method for managing a product level in a storage chamber, comprising:
a. placing a product generator atop a containment device, wherein the product generator creates and dispenses a product, and then delivers the product into a storage chamber of the containment device;
b. determining a product level in the storage chamber by activating a product level determiner with a controller disposed on the containment device;
c. comparing the determined product level to a product height requirement for a current interval of a product height profile; and
d. supplying product to the storage chamber when the determined product level is below the product height requirement for the current interval of the product height profile.

34. The method for managing a product level in a storage chamber according to claim 33, wherein step d. is replaced with:
d. stopping the delivery of product to the storage chamber when the determined product level is above the product height requirement for the current interval of the product height profile.

35. The method according to claim 33, wherein step b. is replaced with:
b. determining a product level in the storage chamber with a controller disposed within the product generator.

36. The method according to claim 33, wherein the containment device is disposed within a product dispenser.

37. The method according to claim 33, wherein the product level determiner includes an optical sensing system.

38. The method according to claim 33, wherein the product level determiner includes thermal probes.

39. The method according to claim 33, wherein steps c. through d. are replaced with:
c. deriving an average usage rate for an elapsed portion of a current interval of a product height profile;
d. projecting an amount of product required to sustain the remainder of the current interval using the derived usage rate;
e. comparing the projected amount of product required to the existing amount of product disposed within the storage chamber; and
f. overriding the product height profile if the projected quantity of product is greater than the determined quantity of product in the chamber, wherein the controller demands product from the product generator to raise the level of product in the storage chamber.

40. The method according to claim 33, wherein steps b. through d. are replaced with:
b. recording the usage over a predetermined period;
c. deriving an average usage for intervals based on a product height profile;
d. creating a “learned” product height profile based on the “learned” usages; and
e. utilizing the “learned” product height profile to adapt to location specific parameters, thereby ensuring adequate product in the storage chamber.

41. The method according to claim 33, wherein step b is replaced with:
b. sampling the voltage of a driver for an agitating means disposed within the storage chamber with a controller, wherein the driver is in communication with the controller; and
c. comparing the sampled voltage to a voltage load profile to determine the level of product disposed within the storage chamber.

42. The method according to claim 33, wherein steps b. through d. are replaced with:
b. delivering sensor inputs for environmental variables for a preselected period to a controller;
c. determining a theoretical product remaining in the storage chamber through cumulative inputs for the preselected period;
d. determining an environmental efficiency factor for existing environmental conditions; and
e. applying the environmental efficiency factor to the theoretical product remaining amount to determine quantity of product remaining in storage chamber.

43. The method according to claim 42, further comprising:
f. converting the quantity of product remaining to a product height measurement.

44. The method according to claim 43, further comprising:
g. comparing the determined product level to a product height requirement for a current interval of a product height profile; and
h. supplying product to the storage chamber when the determined product level is below the product height requirement for the current interval of the product height profile.

45. The method for managing a product level in a storage chamber according to claim 44, wherein step h. is replaced with:
h. stopping the delivery of product to the storage chamber when the determined product level is above the product height requirement for the current interval of the product height profile.
